(19) United States
(12) Patent Application Publication
(10) Pub. No.: US 2007/0220113 A1
(43) Pub. Date: Sep. 20, 2007

(54) Rich presence in a personal communications client for enterprise communications

(76) Inventors: Jerry Knight, New York, NY (US); Andrew Lin, San Francisco, CA (US); Andrew Borovsky, London (GB); Michael Sundermeyer, Palo Alto, CA (US)

Correspondence Address: FULBRIGHT & JAWORSKI, LLP (ADOBE), 2200 ROSS AVENUE, SUITE 2800, DALLAS, TX, 75201-2784, US

(21) Appl. No.: 11/377,924

(22) Filed: Mar. 15, 2006

(51) Int. Cl. G06F 15/16

(52) U.S. Cl. 709/219

(57) ABSTRACT

In various embodiments, a personal communications browser client is provided. In an embodiment, a method is provided. The method includes displaying a set of communications interfaces in a user interface. The method further includes receiving data related to a schedule of communications. Also, the method includes receiving data related to people participating in communications of the schedule of communications. Additionally, the method includes modifying the set of communications interfaces responsive to data related to people participating in communications. Moreover, the method includes predicting upcoming communications sessions responsive to data related to the schedule of communications. The method also includes modifying the set of communications interfaces responsive to the predicting.

### CLAIM OF PRIORITY

This application claims the benefit of priority to United States Provisional Application No. ______, entitled “Rich Presence In A Personal Communications Client For Enterprise Communications” and filed Dec. 31, 2005, which is hereby incorporated herein by reference.

### BACKGROUND

Communications methods through computer and communications networks have evolved from basic methods of the past to a variety of types of communications today. Past communications concerned letter, then telegraph, facsimile and ultimately telephone conversations. Communications since then have evolved to include email, instant messaging, two-way paging, cellular telephones and cellular text messaging. Each of these newer modes of communication involve use of newer technologies. They also rely on networks which may overlap the telephone networks, but also use other network resources. As network resources can be relatively scarce, allowing for efficient use of those resources can be useful.

Managing communications opportunities for a user can also be a useful but daunting task. For example, keeping tabs on when a communication should occur, how it should occur, and where other participants are can be extremely useful, and extremely difficult. Often, a person may have a schedule of communications and meetings in a scheduling program, along with access to contact information which is barely integrated together. Thus, a schedule notice of a meeting (whether in-person or over the phone) and a contact phone number for that person may not be linked. Thus, it would be potentially useful to provide linkage between timing of meetings and information about attendees of meetings.

Additionally, providing an interface for different modes of communications on a computer or machine may be useful. Whether communication is to occur by phone, videoconference, instant messaging or some other mode, this may be transmitted through a computer or may occur in consultation with a computer. Thus, an integrated interface for communications may allow for more efficient use of multiple modes of communication.

### SUMMARY

In various embodiments, a personal communications browser client is provided. In an embodiment, a method is provided. The method includes displaying a set of communications interfaces in a user interface. The method further includes receiving data related to a schedule of communications. Also, the method includes receiving data related to people participating in communications of the schedule of communications. Additionally, the method includes modifying the set of communications interfaces responsive to data related to people participating in communications. Moreover, the method includes predicting upcoming communications sessions responsive to data related to the schedule of communications. The method also includes modifying the set of communications interfaces responsive to the predicting.

In another embodiment, an apparatus is provided. The apparatus includes a server interface. The apparatus also includes a user interface. The user interface includes a set of communications interfaces. The communications interfaces are modifiable responsive to communications scheduling information and user requests. The apparatus further includes a content file including instructions for a media player to execute. The apparatus also includes a media player to access the content file. The media player implements the user interface and the server interface responsive to the instructions of the content file. The media player predicts upcoming communications sessions responsive to communications scheduling information. The media player modifies the user interface responsive to predicting upcoming communications sessions. The media player also receives personal information related to people involved in communications sessions. The media player similarly modifies the user interface to display personal information related to people involved in communications sessions.

In yet another embodiment, a method of providing a communications user interface using a media player is provided. The method includes displaying a set of communications interfaces in a user interface. The method also includes receiving data related to a schedule of communications. The method further includes receiving data related to people participating in communications of the schedule of communications. The method includes modifying the set of communications interfaces responsive to data related to people participating in communications. Moreover, the method includes predicting upcoming communications sessions responsive to data related to the schedule of communications. Also, the method includes modifying the set of communications interfaces responsive to the predicting. Further, the method includes receiving user requests and operating the set of communications interfaces responsive to the user requests.

### BRIEF DESCRIPTION OF THE DRAWINGS

The present invention is illustrated in an exemplary manner by the accompanying drawings. The drawings should be understood as exemplary rather than limiting.

FIG. 1 illustrates an embodiment of a communications interface.

FIG. 2 illustrates an embodiment of a communications user interface.

FIG. 3 illustrates an embodiment of a network of machines used in communications.

FIG. 4 illustrates an alternate view of the embodiment of FIG. 3.

FIG. 5 illustrates an embodiment of a process of operating a communications user interface.

FIG. 6 illustrates an embodiment of a process of storing communications information.

FIG. 7 illustrates an embodiment of a network of machines which may be used in communications.

FIG. 8 illustrates an embodiment of a machine which may be used in communications.

FIG. 9 illustrates an embodiment of a client in a communications system.

FIG. 10 illustrates an embodiment of a process of server-side operations in a communications system.

FIG. 11 illustrates an embodiment of a process of client-side operations in a communications system.

FIG. 12 illustrates another embodiment of a client in a communications system.

FIG. 13 illustrates another embodiment of updating a user interface in a communications system.

FIG. 14 illustrates yet another embodiment of updating a user interface in a communications system.

### DETAILED DESCRIPTION

In various embodiments, a personal communications browser client is provided. The specific embodiments described in this document represent exemplary instances of the present invention, and are illustrative in nature rather than restrictive.

A communications client is provided. The communications client is designed to work with a communications network, whether it is on a device within the communications network, or a remote device which can be connected to the communications network. The communications client is implemented through use of a media player, such as the FLASH player available from Macromedia of San Francisco, Calif. Thus, the communications client may be run through an internet browser, such as the Firefox browser available from Mozilla or the Internet Explorer browser available from Microsoft. The communications client uses a content file to direct the media player. Thereby, a user interface is implemented, along with interfaces to a server or other connection to a communications network, and interfaces to the local device or machine if necessary.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In an embodiment, a method is provided. The method includes displaying a set of communications interfaces in a user interface. The method further includes receiving data related to a schedule of communications. Also, the method includes receiving data related to people participating in communications of the schedule of communications. Additionally, the method includes modifying the set of communications interfaces responsive to data related to people participating in communications. Moreover, the method includes predicting upcoming communications sessions responsive to data related to the schedule of communications. The method also includes modifying the set of communications interfaces responsive to the predicting.

In another embodiment, an apparatus is provided. The apparatus includes a server interface. The apparatus also includes a user interface. The user interface includes a set of communications interfaces. The communications interfaces are modifiable responsive to communications scheduling information and user requests. The apparatus further includes a content file including instructions for a media player to execute. The apparatus also includes a media player to access the content file. The media player implements the user interface and the server interface responsive to the instructions of the content file. The media player predicts upcoming communications sessions responsive to communications scheduling information. The media player modifies the user interface responsive to predicting upcoming communications sessions. The media player also receives personal information related to people involved in communications sessions. The media player similarly modifies the user interface to display personal information related to people involved in communications sessions.

In yet another embodiment, a method of providing a communications user interface using a media player is provided. The method includes displaying a set of communications interfaces in a user interface. The method also includes receiving data related to a schedule of communications. The method further includes receiving data related to people participating in communications of the schedule of communications. The method includes modifying the set of communications interfaces responsive to data related to people participating in communications. Moreover, the method includes predicting upcoming communications sessions responsive to data related to the schedule of communications. Also, the method includes modifying the set of communications interfaces responsive to the predicting. Further, the method includes receiving user requests and operating the set of communications interfaces responsive to the user requests.

In an embodiment, a communications client operable on a remote computer is provided. The client includes a media player and a content file accessible by the media player. The media player operates responsive to the content file. The media player implements the communications client. The media player implements a user interface and a server interface. The media player receives schedule data related to upcoming communications sessions. The media player predicts upcoming communications sessions. The media player modifies the user interface in conjunction with predicted upcoming communications sessions.

In another embodiment, a method is provided. The method includes downloading a communications client operable on a remote computer from a server. The communications client includes a content file which causes a media player to implement the communications client. The client assesses capabilities of the remote computer. The client operates a user interface providing communications capabilities and a communications connection. The client accesses information from a server database. The client receives schedule information related to upcoming communications sessions. The client predicts upcoming communications sessions responsive to the schedule information. The client modifies the user interface responsive to the predicting.

In yet another embodiment, a method is provided. The method includes sending a communications client operable on a remote computer to the remote computer. The communications client includes a content file which causes a media player to implement the communications client. The method further includes routing communications to the communications client on the remote computer. The method also includes sending server data to the communications client on the remote computer. The server data includes schedule data for upcoming communications sessions. The server data enables the communications client to predict upcoming communications sessions and to modify a user interface responsive to the predicted upcoming communications sessions.

In still another embodiment, an apparatus is provided. The apparatus includes a user interface. The apparatus also includes a server interface. The apparatus further includes a content file including instructions for a media player to execute. The apparatus also includes a media player to access the content file on a remote device. The media player implements the user interface and the server interface responsive to the instructions of the content file. The media player receives schedule data related to upcoming communications sessions. The media player predicts upcoming communications sessions responsive to the instructions of the content file. The media player modifies the user interface in conjunction with predicted upcoming communications sessions responsive to the instructions of the content file.

In an embodiment, a method of providing a communications user interface using a media player is provided. The method includes displaying a set of communications interfaces. Also, the method includes receiving data related to a schedule of communications. Furthermore, the method includes predicting upcoming communications sessions responsive to data related to a schedule of communications. The method also includes modifying the set of communications interfaces responsive to the predicting. Moreover, the method includes receiving user requests. Additionally, the method includes operating the set of communications interfaces responsive to the user requests.

In another embodiment, an apparatus is provided. The apparatus includes a server interface. The apparatus also includes a user interface. The user interface includes a set of communications interfaces. The communications interfaces are modifiable responsive to communications scheduling information and user requests. The apparatus additionally includes a media player. The apparatus further includes a content file including instructions for a media player to execute. The media player implements the user interface and the server interface responsive to the instructions of the content file. The media player predicts upcoming communications sessions responsive to communications scheduling information. The media player modifies the user interface responsive to predicting upcoming communications sessions.

In still another embodiment, a method is provided. The method includes displaying a set of communications interfaces in a user interface. The method also includes receiving data related to a schedule of communications. The method further includes predicting upcoming communications sessions responsive to data related to a schedule of communications. The method additionally includes modifying the set of communications interfaces responsive to the predicting.

In an embodiment, a method of providing a communications user interface using a platform-independent virtual machine operating responsive to a content file is presented. The method includes displaying a set of communications interfaces. The method also includes receiving data related to a schedule of communications. Furthermore, the method includes predicting upcoming communications sessions responsive to data related to a schedule of communications. Moreover, the method includes modifying the set of communications interfaces responsive to the predicting. Additionally, the method includes operating the set of communications interfaces responsive to the user requests.

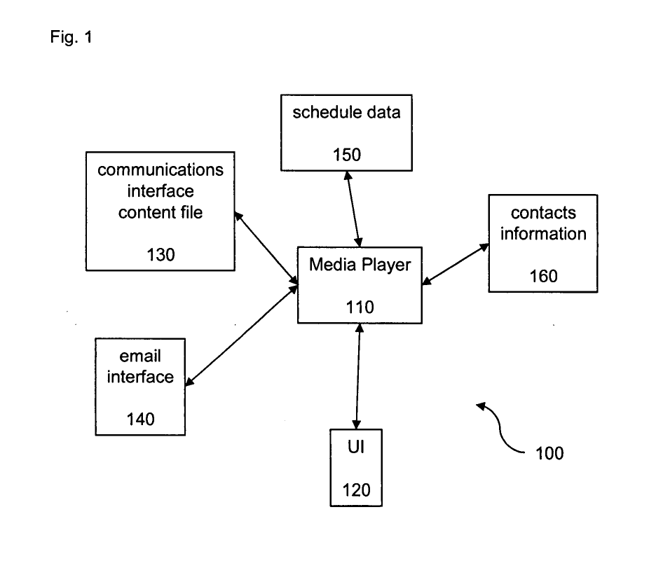

Various embodiments of the invention may be appropriate to different circumstances. FIG. 1 illustrates an embodiment of a communications interface. Communications interface 100 includes a media player, user interface, email interface, content file, schedule data and contact information. Media player 110 may be a player such as Macromedia FLASH player, for example. It may be expected to use content file 130 to present user interface 120. In some embodiments, this is done in a device-independent manner, such that media player 110, operating on most devices or machines, renders user interface 120 in essentially the same way responsive to content file 130.

In various embodiments, email interface 140, scheduling data interface 150 and contacts information interface 160 are also provided. Interfaces 140, 150 and 160 may be separate components or modules, or may be provided as a result of execution of content file 130 by media player 110. Similarly, user interface 120 may be provided as a result of operation of media player 110, or it may be a separate component or module which is transformed through operation of media player 110, for example.

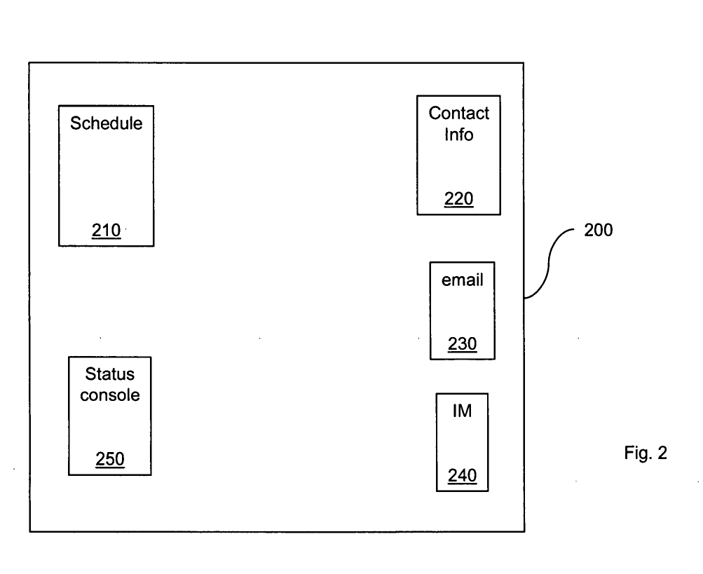

The user interface involved in a communications interface may take on a variety of forms. FIG. 2 illustrates an embodiment of a communications user interface. User interface 200 includes a schedule interface, contact information interface, email interface, IM (instant messaging) interface and a status console. Schedule interface 210 may be an interface to a calendaring program and data repository, for example. Similarly, contact information interface 220 may be an interface to a contact management system and repository. Moreover, email interface 230 may be an interface to an email program and email data repository. Additionally, the email repository may share data with the contacts repository, for example. IM interface 240 may be an interface to an instant messaging program or similar peer-to-peer technology.

Also provided is status console 250, which may display status for the user of the system. Status information may relate to connectivity (of networks for email or IM, for example) and alerts (messages) from various communications applications, including the interfaces 210, 220, 230 and 240. Status console 250 may also include an interface allowing a user to set parameters for incoming communications. These parameters may include an indication of what type of communications are acceptable (e.g. email is ok, phone is not), whether a user is busy (no communications) or free (any communications). Additionally, more specific parameters may be set, relating to rules such as a condition on when specified users may call or email, or whether communications from a class of users may come through.

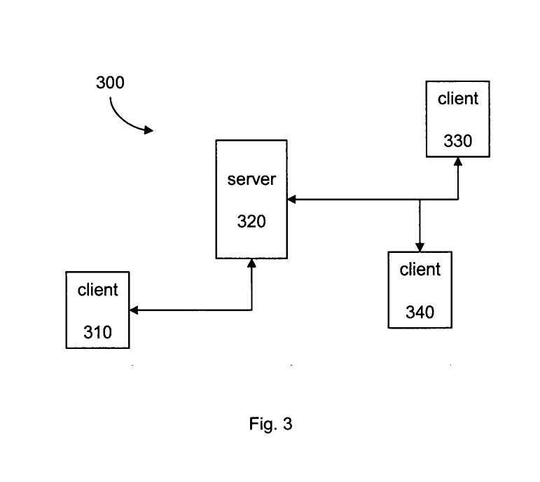

Typically, communications will occur between a network of machines. Whether the network is used exclusively (communication between two machines on the network) or is part of an overall system (communications between two machines where at least one is not connected directly to the network), a network of machines will be involved. FIG. 3 illustrates an embodiment of a network of machines used in communications. Network 300 includes a server and a set of networked client computers. Server 320 may be a conventional server through which some communications may be routed and at which some related data may be stored. Clients 310, 330 and 340 may be client devices of various types coupled to server 320. For example, a local network may couple clients 330 and 340 to server 320. A wireless connection may couple client 310 to server 320. Similarly, clients 310, 330 and 340 may be computers, personal devices (e.g. personal digital assistants, cellphones, two-way pagers), terminals, or other suitable devices.

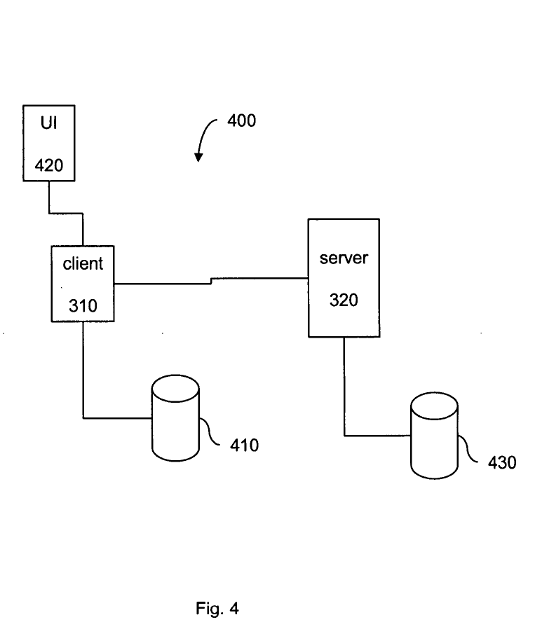

FIG. 4 illustrates an alternate view of the embodiment of FIG. 3. As illustrated, a client may have a user interface and a local repository coupled thereto. Similarly, a server may have a repository on the server side. Client 310 is illustrated with a local repository 410, typically a data repository embodied in mass storage media, in which local contact, scheduling and other data may be found. User interface 420 is also provided, allowing for user access to client 310, and thus for communications utilizing client 310. Similarly, server 320 is illustrated as having server data storage 430, a data repository embodied in mass storage media. Server data 430 may embody contact information or scheduling information which is accessible within an organization, for example. Moreover, server data 430 may embody network accessible personal information for a user, such as a profile of user settings or authorizations, for example.

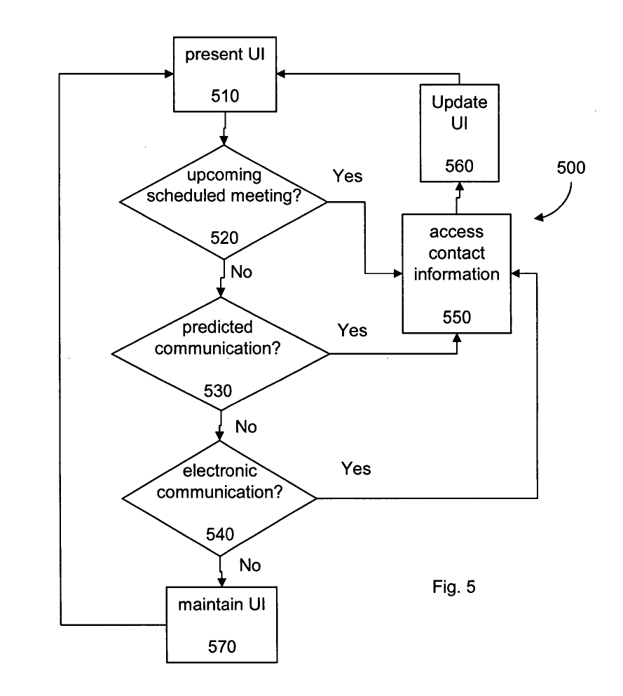

Various processes may be used to implement communications between machines. FIG. 5 illustrates an embodiment of a process of operating a communications user interface. Process 500 includes presenting a user interface, determining a meeting is coming up, predicting a communication, sensing an electronic communication, and either maintaining the user interface or accessing contact information and updating the user interface. Process 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

Process 500 initiates with presentation of a user interface at module 510. The user interface may be presented as part of a graphical user interface, for example. At module 520, a determination is made as to whether an upcoming meeting is on a schedule for a user. This may occur as a result of a check of a calendar or an alert from a calendar, for example. If a meeting is upcoming, contact information for participants in the meeting may be accessed in a contacts database at module 550. Moreover, the user interface may be updated at module 560 to reflect the status of the meeting and information about participants. This information may include whether the participants will be available, how to contact them (mode of communication) and where to contact them (location/address) for example.

At module 530, another determination is made, as to whether a predicted communication is to occur. A predicted communication may be one that happens as a result of a pattern, or one that was tentatively scheduled but never finalized, for example. Thus, if a client always calls at 9:30 AM on Mondays, this may be predicted. Similarly, if a certain person always (almost always) initiates an IM session at 2:30 PM, that may be predicted. Also, at module 540, an electronic communication may be detected, such as an incoming request for an IM session or an incoming email, for example. Thus, modules 520, 530 and 540 serve to detect or predict various communications events. Modules 520, 530 and 540 may operate in a series or parallel fashion, for example. If no communications are coming up, the user interface may be maintained at module 570, and the process may repeat.

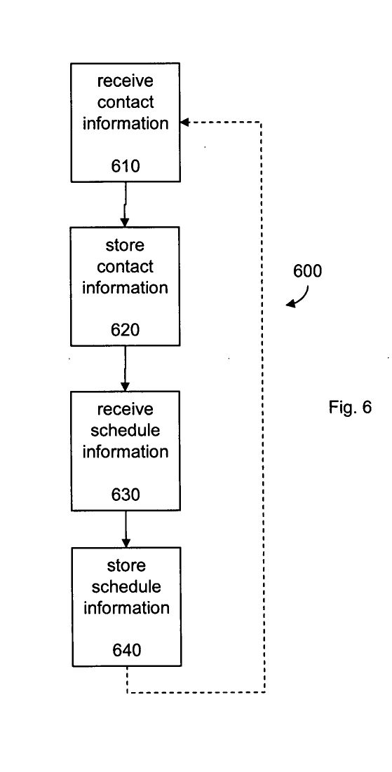

Information related to communications and communications processes may be provided by a user at communication time, or retrieved from some form of repository. Either way, a communications process will typically involve some form of address/dialing information useful in initiating contact for communications purposes. FIG. 6 illustrates an embodiment of a process of storing communications information. Process 600 includes receiving and storing contact information, and receiving and storing scheduling information. Scheduling and contact information may be stored in a local repository, on a networked or server repository (potentially a remote repository), or in some other place for data storage. At module 610, contact information (data) is received. At module 620, the contact information is stored. Similarly, at module 630, schedule information or data is received. Schedule data is then stored at module 640. This process may repeat as needed to store information, and may be expected to repeat as meetings or other communications are scheduled, and similarly as contact information for people and organizations is received or updated. Moreover, while this is depicted as a linear or serial process, it may well occur in a more parallel fashion, as a result of operations by multiple users in a network, for example.

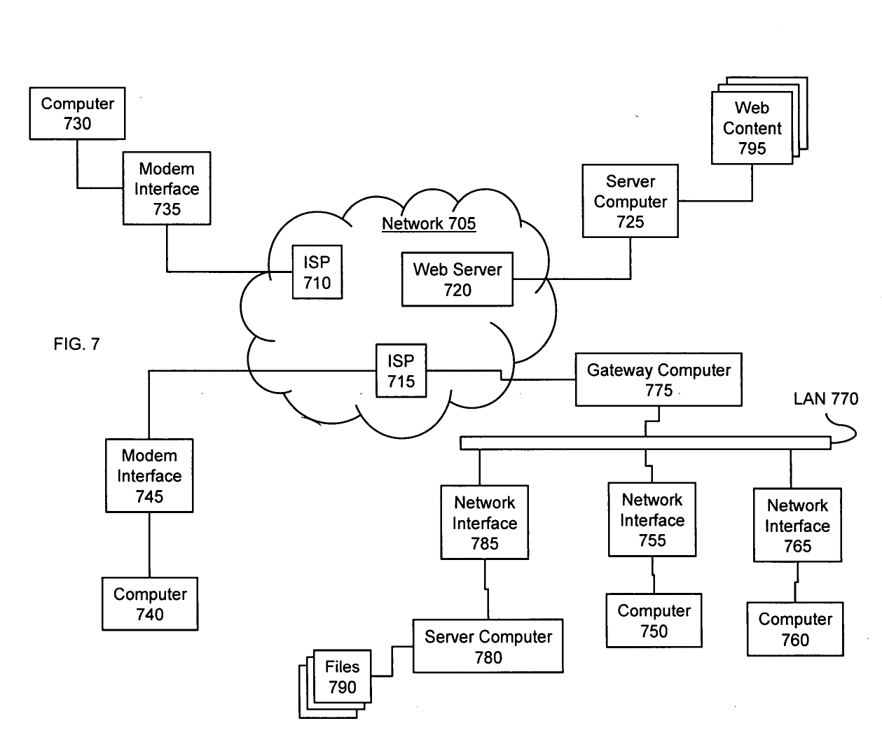

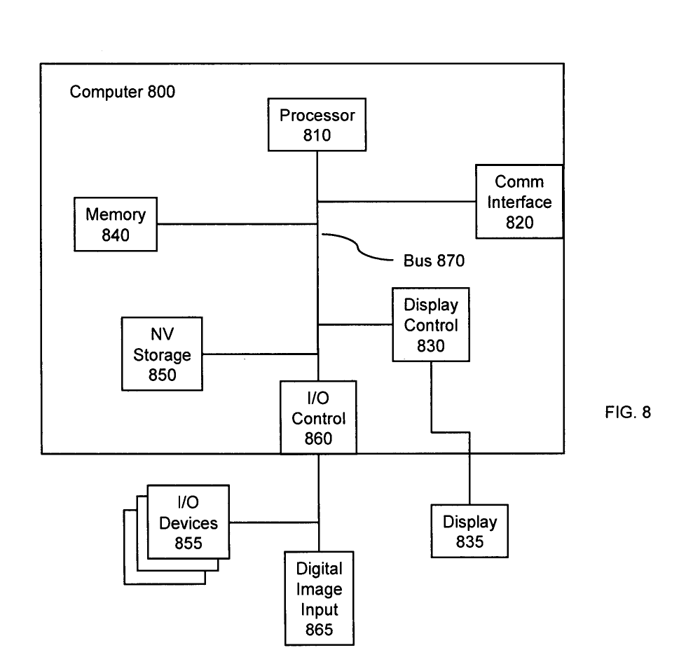

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

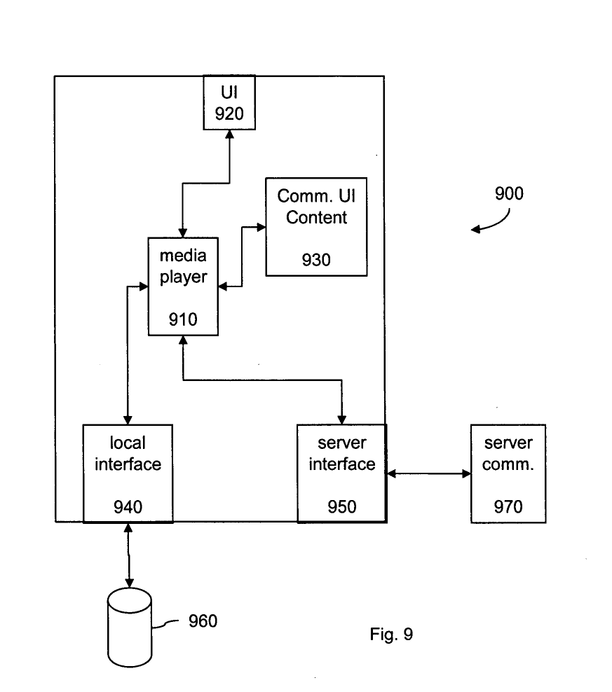

Clients may be implemented on a variety of systems, such as those represented in FIGS. 7 and 8, for example. FIG. 9 illustrates an embodiment of a client in a communications system. Client 900 includes a media player, content file, user interface, local interface and server interface. Client 900 may be embodied in a machine-readable medium (or media), or may be implemented as a standalone application or appliance, for example.

Client 900 includes media player 910, such as Macromedia FLASH player, which operates a user interface 920 based on a communications user interface content file 930 (content file 930). Media player 910 may be expected to work through a local interface 940 to access local memory or data 960 in some circumstances, and may similarly be expected to work through a server interface 950 to access server communications 970.

Thus, client 900 may be a component or module which is downloaded to a device or computer, and may operate in either a standalone or a plug-in fashion, for example, depending on device capabilities and implementation details. If client 900 is used on a computer regularly used by a user, it may work with a local repository 960. Alternatively, if client 900 is used on a public computer, it may access data through server communications 970, avoiding local storage of potentially sensitive data. Thus, client 900 may be used to integrate with a communications environment, and provide a user interface such as that described with respect to FIG. 2. Various implementations of client 900 may be used on various different devices.

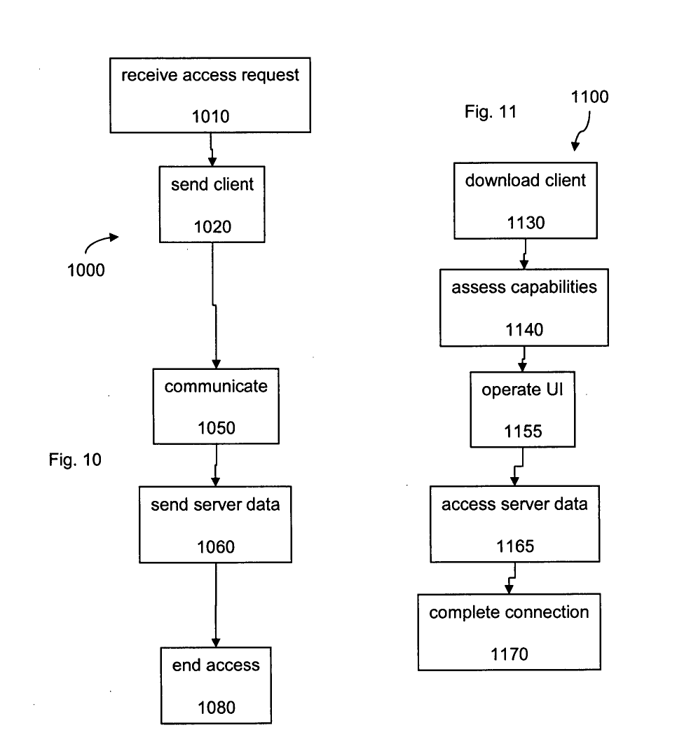

A client will typically operate in conjunction with a server, so a process may be executed by a server to service the client. FIG. 10 illustrates an embodiment of a process of server-side operations in a communications system. Process 1000 includes receiving an access request, sending a client, communicating, sending server data, and ending access. Thus, process 1000 relates to providing communications software (the client) and servicing that software from the server side in some embodiments.

Process 1000 begins with receipt of an access request at module 1010, such as may occur when a user logs in at a website for a communications interface. At module 1020, a communications client is sent to the user responsive to the access request. This may involve assessing client capabilities from the server-side to send the proper client software. Thus, a personal digital assistant or cell phone may involve a different client from a public computer, for example. Responsive to operation of the client software, the server communicates with the client at module 1050, such as by passing along email and IM traffic, for example. Additionally, responsive to requests from the client, server data is sent to the client at module 1060. Such data may include server-based contact information and schedules, for example. Modules 1050 and 1060 may be executed or operated in an iterative or looping fashion for multiple communications sessions, for example. With an end to access, such as through a logout request or some form of disconnection, access is terminated at module 1080.

Just as a server may operate a process to provide communications capabilities, a client may also implement a communications process. FIG. 11 illustrates an embodiment of a process of client-side operations in a communications system. Process 1100 includes downloading a client, assessing capabilities, operating a user interface, accessing server data, and completing a connection. Thus, client-side operations may occur, starting with downloading a client application or software module appropriate for available client components.

At module 1130, a client is downloaded from a server. The client is typically a software component or module, and thus may be anything from a plug-in for a browser to a standalone application, depending on client equipment. At module 1140, capabilities of the client environment are assessed, such as communications hardware available, other resources, and connectivity, for example. At module 1155, a user interface is operated by the client, whether in a standalone application or as a plug-in to a browser, for example. Typically, the user interface will be operated by a media player using a content file. Operation of the user interface includes initiation and maintenance of communications sessions, among other functions. At module 1165, server data is accessed, such as server-based scheduling or contact data, for example. Note that the process may iterate or switch between modules 1155 and 1165 to achieve several communications sessions, for example. Upon completion of communications, a user disconnect signal of some form is received at module 1170, and the connection is completed or disconnected, such as by signaling the server.

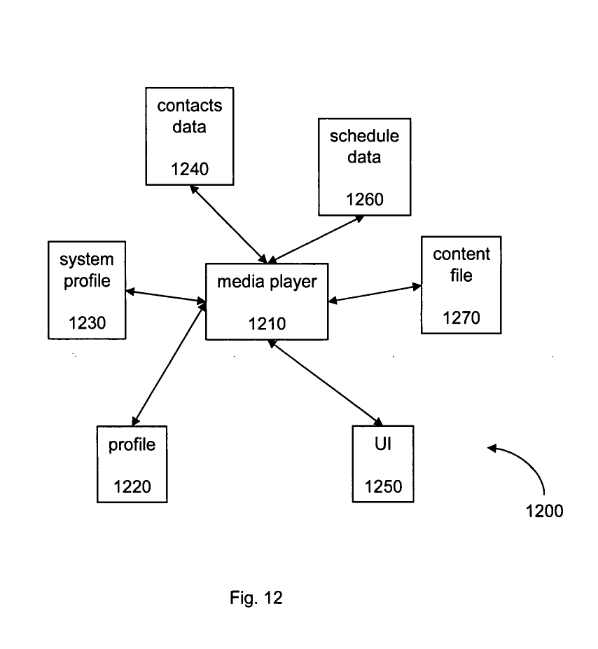

Various embodiments of a communications system or client may be used with the overall communication system described and illustrated. FIG. 12 illustrates another embodiment of a client in a communications system. System 1200 may represent a client and modules or components accessed by the client, including a media player, content file, contacts data, schedule data, user interface, profile and system profile.

The client is implemented by the media player 1210 responsive to the content file 1270. A user interface 1250 is displayed, with components of the user interface 1250 varied based on information from contacts data 1240 and schedule data 1260. Thus, the user interface 1250 may be similar to the user interface of FIG. 2, with information displayed based on upcoming meetings or people expected to be contacted.

Additionally, profile 1220 provides information about how the user wants the user interface 1250 to appear—such as providing various user preferences. Profile 1220 may also provide permissions or capabilities of the user—thereby indicating to the system what the user should and should not be able to do. In cases of strong encryption or security, digitally signed profiles may be used, for example. Profile 1220 may also include user customizable data of a more temporary form, such as recording whether the user is currently accessible, what forms of communication are acceptable at certain times (e.g. no instant messages during a computer presentation or web conference).

Thus, profile 1220 can provide information about how a user is willing to receive communications, and this information can be set by the user. Additionally, system profile 1230 represents information about other users within the system. Thus, system profile 1230 may represent a system file with entries for users of the system, or it may represent the profiles of other users on the system as presently available, for example. With system profile 1230, information can be provided about other users, such as whether the user is in an assigned office or at a pre-scheduled meeting, for example. Also, system profile provides preferences of other users, allowing for use of mutually agreeable forms of communication (e.g. email, instant messaging, etc.)

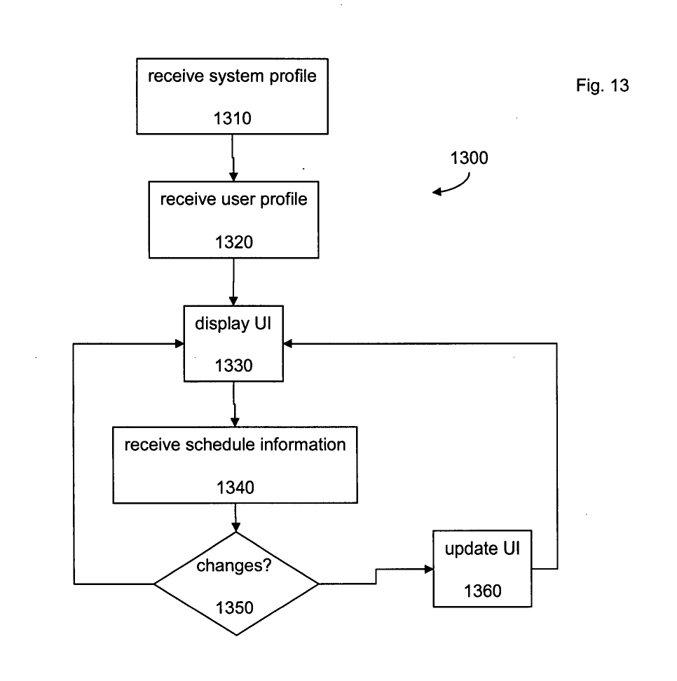

With the system in place, processes can be used to provide and update a user interface based on information available in the system. FIG. 13 illustrates another embodiment of updating a user interface in a communications system. Process 1300 includes receiving a system profile, receiving a user profile, displaying a user interface, receiving schedule information, detecting changes, and updating the user interface.

Process 1300 initiates with receipt of system profile information at module 1310. This system profile information may include information about other users on the system—indicating how they may be contacted in terms of modes of communication and address/phone number information. Additionally, system profile information may include information about what a layout should be for a user interface, for example.

At module 1320, user profile information is received. User profile information may include preset information about how a user will accept communications (what mode, such as telephone, email, etc.) User profile information may also include information about user-specific customization of the user interface, for example. Thus, specific ways of presenting information may effectively be encoded in the profile.

At module 1330, the user interface is displayed. This may occur based on input received from various potential communications users, and/or based on information derived from the profiles. At module 1340, schedule information for the user is received. At this point, the user can make sure the schedule agrees with personal memory or recent changes. Additionally, at module 1350, a determination is made as to whether the user interface needs to change based on schedule information. If so, then the user interface is updated at module 1360. If not, the user interface is displayed as is at module 1330.

The process of modules 1330, 1340, 1350 and 1360 can then repeat, taking into account later schedule information for meetings, web conferences, and the like, and updating the user interface as appropriate. Moreover, changes in system information (availability of people for example) may also constitute changes at module 1350. Module 1360 would then respond to changes in availability by updating the user interface.

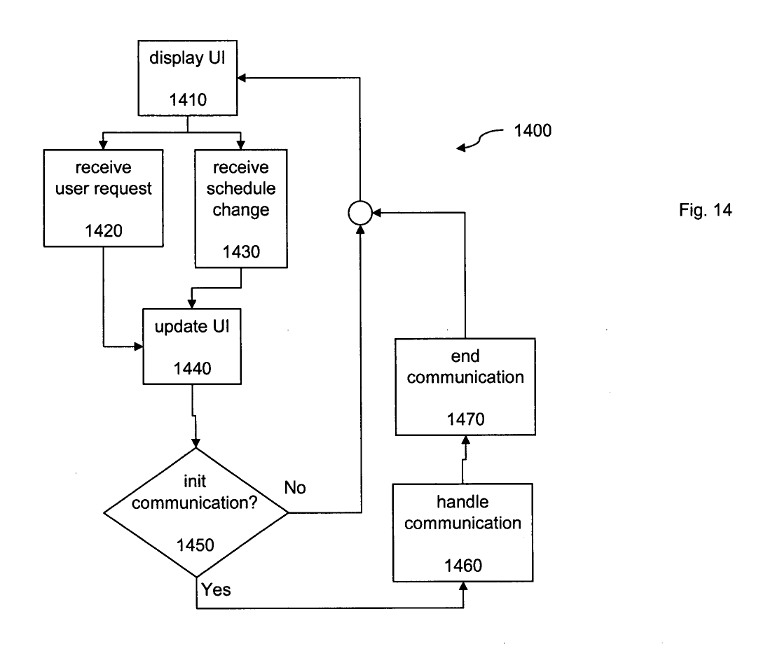

Operation of the client in a communications scenario may provide further details. FIG. 14 illustrates yet another embodiment of updating a user interface in a communications system. Process 1400 includes displaying a user interface, receiving a user request or a schedule change, updating the user interface, determining if communication is starting, handling the communication and ending the communication.

Process 1400 is illustrated as starting with display of a user interface at module 1410. This likely presumes some sort of setup of the user interface based on profiles has already occurred. Next, either at module 1420 or module 1430, an event triggers a change in the user interface. A user request at module 1420 may relate to looking for information about another user (in order to contact that other user, for example), Similarly, a user request at module 1420 may be a request to initiate communication.

A schedule change at module 1430 represents a simple schedule change or some other change in status within the system. Thus, an upcoming meeting may trigger module 1430. Alternately, a user indicating lack of availability (e.g. telling the system to not accept phone calls) may trigger module 1430.

At module 1440, the user interface is updated. This may relate to some form of escalation or de-escalation of part of the system, for example. Alternatively, it may relate to updating a relatively static display with new information. The new information may take the form of updated contact information or may take the form of different permissions from a user for interaction with other users or use of modes of communication.

At module 1440, a determination is made as to whether communication is starting. If not, the user interface is displayed in its current form at module 1410. If so, the communication is handled by the client/system at module 1460. The communication is eventually terminated by the client/system at module 1470. Handling the communication may include expanding a window in the user interface for a web-conference or piping telephone audio through a computer's microphone and speakers, for example. Additionally, ending the communication may involve contracting a window in the user interface or otherwise reshaping the user interface.

One skilled in the art will appreciate that although specific examples and embodiments of the system and methods have been described for purposes of illustration, various modifications can be made without deviating from the spirit and scope of the present invention. Similarly, features and aspects of various embodiments may be integrated into other embodiments, and embodiments illustrated in this document may be implemented without all of the features or aspects illustrated or described. For example, embodiments of the present invention may be applied to many different types of databases, systems and application programs. Moreover, features of one embodiment may be incorporated into other embodiments, even where those features are not described together in a single embodiment within the present document. While embodiments described herein are intended to be exemplary, these embodiments provide examples of embodiments of the present invention.

What is claimed is:

1. A method, comprising:
displaying a set of communications interfaces in a user interface;
receiving data related to a schedule of communications;
receiving data related to people participating in communications of the schedule of communications;
modifying the set of communications interfaces responsive to data related to people participating in communications;
predicting upcoming communications sessions responsive to data related to the schedule of communications; and
modifying the set of communications interfaces responsive to the predicting.

2. The method of claim 1, wherein:
the data related to people participating in communications includes personal status information for people.

3. The method of claim 2, wherein:
the data related to people participating in communications includes contact information for people.

4. The method of claim 3, wherein:
the set of communications interfaces includes an email interface.

5. The method of claim 3, wherein:
the set of communications interfaces includes a peer-to-peer communications interface.

6. The method of claim 3, wherein:
the set of communications interfaces includes a chat interface.

7. The method of claim 3, wherein:
the set of communications interfaces includes a voice-over-IP communications interface.

8. The method of claim 3, wherein:
the set of communications interfaces includes a videoconference communications interface.

9. The method of claim 3, further comprising:
showing data related to people participating in an incoming communication request.

10. The method of claim 9, wherein:
the set of communications interfaces includes a peer-to-peer communications interface, a voice-over-IP communications interface, and a videoconference communications interface.

11. The method of claim 3, further comprising:
accessing data related to people participating in communications responsive to a user request.

12. The method of claim 3, further comprising:
setting personal information for a user of the user interface responsive to user input of personal information.

13. The method of claim 12, wherein:
the personal information set for the user includes personal status information.

14. The method of claim 13, wherein:
the personal information set for the user includes personal contact information.

15. The method of claim 13, wherein:
setting personal information for the user includes setting rules for contacting the user.

16. The method of claim 15, wherein:
the rules for contacting the user are based on identifying information related to people attempting to contact the user.

17. The method of claim 15, wherein:
the rules for contacting the user are based on activities engaged in by the user.

18. The method of claim 1, wherein:
the method is performed by a processor executing instructions, the instructions embodied in a medium, the instructions causing the processor to perform the method through execution of a media player responsive to a content file.

19. An apparatus, comprising:
a server interface;
a user interface, the user interface including a set of communications interfaces, the communications interfaces modifiable responsive to communications scheduling information and user requests;
a content file including instructions for a media player to execute, a media player implementing the user interface and the server interface responsive to the instructions of the content file, the media player predicting upcoming communications sessions responsive to communications scheduling information, the media player modifying the user interface responsive to predicting upcoming communications sessions, the media player receiving personal information related to people involved in communications sessions, the media player modifying the user interface to display personal information related to people involved in communications sessions;
and
a media player to access the content file.

20. The apparatus of claim 19, further comprising:
means for accessing data related to people involved in communications sessions.

21. The apparatus of claim 19, further comprising:
a personal data interface to access data related to people involved in communications sessions of a data repository.

22. The apparatus of claim 13, wherein:
the media player is embodied in a medium as instructions, the instructions executed by a processor.

23. A method of providing a communications user interface using a media player, comprising:
displaying a set of communications interfaces in a user interface;
receiving data related to a schedule of communications;
receiving data related to people participating in communications of the schedule of communications;
modifying the set of communications interfaces responsive to data related to people participating in communications;
predicting upcoming communications sessions responsive to data related to the schedule of communications;
modifying the set of communications interfaces responsive to the predicting;
receiving user requests;
and
operating the set of communications interfaces responsive to the user requests.

24. The method of claim 23, further comprising:
showing data related to people participating in an incoming communication request.

25. The method of claim 24, wherein:
the set of communications interfaces includes one or more of the group consisting of a peer-to-peer communications interface, a voice-over-IP communications interface, an email interface, a chat interface, and a videoconference communications interface.

26. The method of claim 23, further comprising:
receiving authentication of user identity;
and
unlocking the set of communications interfaces responsive to authentication.

27. The method of claim 23, further comprising:
accessing data related to people participating in communications responsive to a user request.

28. The method of claim 23, further comprising:
setting personal information for a user of the user interface responsive to user input of personal information.

29. The method of claim 23, further comprising:
displaying status of the communications interfaces of the set of communications interfaces in a status console in the user interface.
